(19) United States
(12) Patent Application Publication
(10) Pub. No.: US 2006/0077459 A1
(43) Pub. Date: Apr. 13, 2006

(54) Information processing system and information processing method

(75) Inventor: Yuji Matsueda, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/248,282

(22) Filed: Oct. 13, 2005

(30) Foreign Application Priority Data
Oct. 13, 2004 (JP) P2004-299012

(51) Int. Cl. G06F 3/12

(52) U.S. Cl. 358/1.15

(57) ABSTRACT

A first information processing device and a second information processing device are connected to the first information processing device by way of a network. A communicator is provided in the first information processing device and adapted to establish communications with the second information processing device. A communications protocol is provided in the second information processing device, and configured to transmit a search signal indicative of a searched object to the network. The communicator is adapted to transmit a response indicative of a search result with respect to the search signal to the second information processing device.

### BACKGROUND OF THE INVENTION

The present invention relates to an information processing system, and an information processing method.

Japanese Patent Publication No. 11-163902A discloses an information processing system in which a plurality of information processing devices such as computers, printers, and scanners are connected via a LAN (Local Area Network).

In this information processing system, IP (Internet Protocol) addresses each used for specifying a computer or an information processing device in the network have been registered beforehand, whereby a user specifies the computer by way of a control panel of the information processing device, to thus cause the computer to execute specific processing.

The method for specifying a computer or an information processing device in a network includes another method using an application which is disclosed in Japanese Patent Publication No. 2002-335366A. This application stocks in a file server with scanned data which have been obtained by scanning an original by use of a scanner, and then enables the user to make an access the data from the user's computer. This application has been installed in the server in advance. For instance, when the user makes an access to the file server, the server transmits the scanned data to the computer.

In the case of the information processing systems described in the above publications, in order to remotely operate the computer from the information processing device, the user has a smaller chance of skipping between the computer and the information processing device. However, the user can remotely operate only the previously-registered specific computer. Further, the user cannot ascertain, from the information processing device, whether or not the registered computer has been activated. Thus, the information processing systems are deficient in terms of convenience.

### SUMMARY OF THE INVENTION

It is therefore an object of the invention to provide an information processing system and an information processing method which enable to locate a computer connected to a network without having specified the computer or an information processing device in the network beforehand.

In order to achieve the above object, according to the invention, there is provided an information processing system, comprising:

a first information processing device;

a second information processing device, connected to the first information processing device by way of a network;

a communicator, provided in the first information processing device and adapted to establish communications with the second information processing device; and

a communications protocol, provided in the second information processing device, and configured to transmit a search signal indicative of a searched object to the network,

wherein the communicator is adapted to transmit a response indicative of a search result with respect to the search signal to the second information processing device.

With this configuration, a respondable first information processing device can be located in the network from the second information processing device, Therefore, it is possible to establish communications between the first information processing device and the second information processing device without specifying the first information processing device in advance.

The communicator may be operable to search an application which has been installed in the first information processing device. In this case, since such an application can be recognized at the side of the second information processing device, it is not necessary to directly operate the first information processing device to search the application.

Here, the application may be adapted to control the second information processing device. In this case, data acquisition from the second information processing device can be executed from the first information processing device with the application capable of controlling the second information processing device.

Alternatively, the application may be adapted to process data transmitted from the second information processing device. In this case, it is possible to easily recognize a first information processing device capable of processing data owned by the second information processing device.

Further, the second information processing device may comprise an instruction provider adapted to provide a first instruction, and a display. The search signal may be transmitted in accordance with the first instruction, and the display is adapted to display the search result.

With this configuration, a user can select a first information processing device capable of processing data owned by the second information processing device in accordance with the displayed search result.

Here, the second information processing device may comprise a data storage. The instruction provider may be adapted to provide a second instruction which is input in accordance with the search result displayed in the display so as to include first information about the first information processing device second information about the second information processing device and third information about the application. The communications protocol may be configured to transmit the first information, the second information, and the third information in accordance with the second instruction. The first information processing device may be configured to activate the application in accordance with the third information, and to acquire data stored in the data storage in accordance with the second information.

The second information processing device may comprise an image processor. In this case, data produced by image processing performed in the second information processing device can be utilized in the first information processing device. A scanner and a digital camera are exemplified as such a second information processing device.

The first information processing device may comprise an image processor. In this case, image processing can be performed in the first information processing device to process data acquired from the second information processing device. A printer and a projector are exemplified as such a first information processing device.

According to the invention, there is also provided an information processing device adapted to be connected to a network, comprising:

an instruction provider, adapted to provide a first instruction including a searched object;

a communications protocol, configured to transmit a search signal to the network in accordance with the first instruction, and adapted to receive a response indicative of a search result with respect to the search signal; and

a display, adapted to display the search result.

The instruction provider may be adapted to provide a second instruction which is input in accordance with the search result displayed in the display so as to designate an external device connected to the information processing device by way of the network The communications protocol may be configured to transmit information to the external device in accordance with the second instruction.

According to the invention, there is also provided an information processing device adapted to be connected to a network, comprising:

an application, being installed in advance; and

a communicator, adapted to receive a search signal indicative of a searched object from an external device connected to the information processing device by way of the network, to search the application as the searched object, and to transmit a response indicative of a search result with respect to the search signal to the external device.

The communicator may be adapted to receive a request for activating the application from the external device, and to acquire data from the external device when the application is activated in accordance with the request.

According to the invention, there is also provided an information processing method, comprising:

connecting a first information processing device and a second information processing device by way of a network;

causing the second information processing device to locate the first information processing device in the network and to search an application which has been installed in the first information processing device;

causing the first information processing device to transmit a response indicative of a search result to the second information processing device; and

causing the second information processing device to display the search result.

The information processing method may further comprises:

causing the second information processing device to transmit information including an instruction which is input in accordance with the displayed search result, to the first information processing device; and

causing the first information processing device to activate the application in accordance with the instruction, and to acquire data from the second information processing device.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a schematic view showing an information processing system according to one embodiment of the invention;

FIG. 2 is a perspective view of a multifunction apparatus in the information processing system;

FIG. 3 is a block diagram showing the information processing system;

FIG. 4 is a flow chart showing a method for searching an application and a method for transmitting scanned data, which are executed in the information processing system;

FIG. 5A is an enlarged plan view of a control panel of the multifunction apparatus;

FIGS. 5B to 5F are enlarged views of exemplified screens displayed on a display panel in the control panel;

FIG. 6 is a flow chart showing processing executed by when a net scan module in the computer is activated;

FIG. 7 is a flow chart showing discovery processing executed by the net scan module;

FIG. 8 is a flow chart showing processing executed by the net scan module when a start button in the control panel is actuated;

FIGS. 9A to 9F are enlarged views of exemplified screens displayed on a display panel in a control panel according to a modified example; and

FIG. 10 is a flow chart showing event processing executed by a net scan module according to another modified example.

### DETAILED DESCRIPTION OF THE EMBODIMENTS

Embodiments of the invention will be described below in detail with reference to the accompanying drawings.

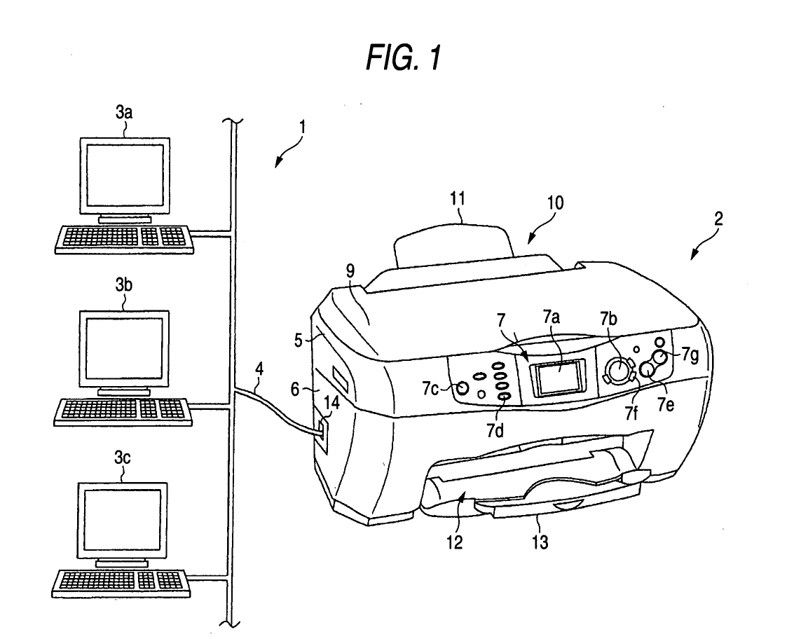

As shown in FIG. 1, in an information processing system 1 according to one embodiment of the invention, a multifunction apparatus 2 having three functions (a scanner function, a printer function, and a copy function) is connected to a plurality of computers 3a, 3b, and 3c by way of a LAN cable 4.

The multifunction apparatus 2 comprises a scanner section 5 for reading scanned data (image data) from an original; and a printer section 6 for printing an image on a print medium, such as a sheet of paper, on the basis of the scanned data. The multifunction apparatus 2 has a control panel 7 serving as a user interface operated by the user for performing various operations.

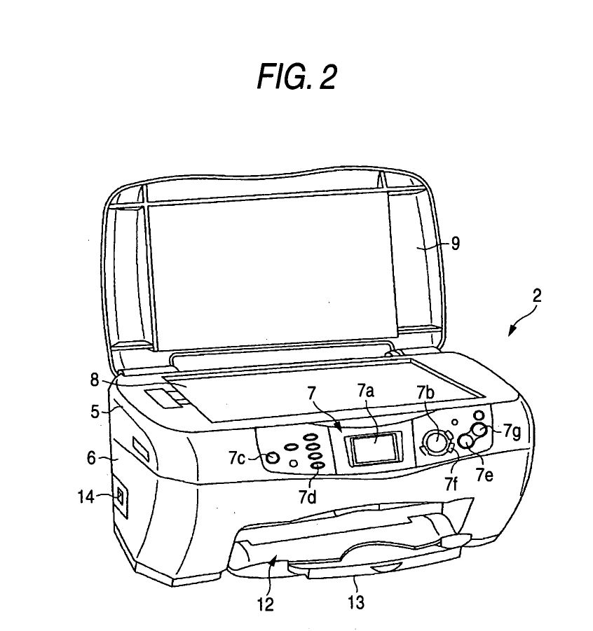

As shown in FIG. 2, the scanner section 5 is situated above the printer section 6, and has an original table 8 on which an original to be scanned is placed; and a cover 9 which covers the original table 8 from above. A carriage, or the like, on which an ink cartridge is to be mounted is positioned in the printer section 6. The scanner section 5 is pivotably attached to a rear upper end of the printer section 6 by way of a hinge section. The inside of the printer section 6 is exposed by lifting the scanner section 5 upward. By doing so, maintenance operation, such as replacement of an ink cartridge, or fixing of an error, such as a paper jam, can be performed.

A feeder 10 for feeding a sheet to a printer section 6 is provided on the back of the multifunction apparatus 2. The feeder 10 is provided with a sheet feeding tray 11 for holding sheets. An ejector 12, from which a sheet having been subjected to printing performed by the printer section 6 is ejected, is provided at a lower position of the front side of the multifunction apparatus 2. The ejector 12 has a sheet ejecting tray 13 adapted to close an ejection port.

For instance, a LAN port 14 is provided for establishing connection with an external device, on a side section of the multifunction apparatus 2. In this embodiment, the LAN port 14 connects the multifunction apparatus 2 to the plurality of (three in this embodiment) computers 3a, 3b, and 3c by way of the LAN cable 4 (through LAN connection). As a result of having been connected to the computers 3a to 3c, this multifunction apparatus 2 can execute print processing (driver printing) or scan processing (driver scanning) on the basis of a control command issued by any of the computers 3a to 3c.

The control panel 7 has a display section 7a on which a setting screen, such as a sheet size, a print counter, or the like, is displayed, and an operating section 7b consisting of a plurality of operation buttons. The operating section 7b comprises: a power button 7c used for activating/deactivating the multifunction apparatus 2; a scan button 7d used for initiating an original-reading function of the scanner section 5; a start button 7e used for initiating copying operation or operation for reading an original; and an OK button 7f used for, for example, activating a function for locating the computers 3a to 3c in the LAN or a function for searching for an application (described later in detail).

When an original is set on the scanner section 5 and the scan button 7d is actuated, the multifunction apparatus 2 serves as a scanner for reading scanned data (image data) from the original by use of the scanner section 5.

As a result of being connected to the computers 3a to 3c by way of the network, the multifunction apparatus 2 serves also as a printer for effecting printing operation by use of the printer section 6 on the basis of print data transferred from the computers 3a to 3c. When the original is set on the scanner section 5 and a copy button 7g is actuated, the multifunction apparatus 2 serves also as a copier, In this case, the multifunction apparatus 2 reads scanned data from the original by use of the scanner section 5, coverts the scanned data into print data, and prints an image on the basis of the print data by use of the printer section 6.

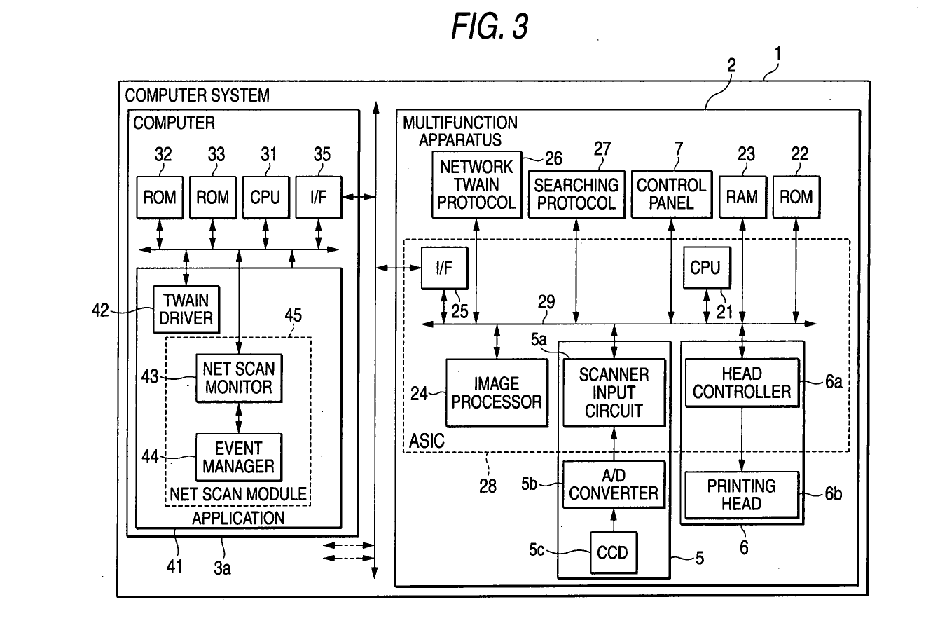

As shown in FIG. 3, in the information processing system 1, the multifunction apparatus 2 and the computer 3a (the computers 3b, 3c are omitted for the sake of convenience) are connected together by the LAN cable 4.

The multifunction apparatus 2 comprises: the scanner section 5; the printer section 6; the control panel 7; a CPU 21 for controlling these elements; a ROM 22; a RAM 23; an image processor 24; and an interface (I/F) 25 used for establishing a connection with the LAN. In addition, the multifunction apparatus 2 comprises a network TWAIN protocol 26 and a searching protocol 27 which acts as a protocol used for locating a computer in the LAN. This searching protocol 27 transmits a search signal to the network.

The CPU 21 is mounted in a built-in ASIC (Application-Specific Integrated Circuit) 28 provided in the multifunction apparatus 2. Along with the CPU 21, a scanner input circuit 5a, a head controller 6a, the previously-described image processor 24, and the interface 25 are mounted in the ASIC 28 along with the CPU 21. These circuits are connected together by way of an internal bus 29. The above-described ROM 22, the RAM 23, and the control panel 7, which are to be externally connected to the ASIC 28, are also connected to the internal bus 29.

The ROM 22 stores various control programs which are necessary for the CPU 21 to execute processing. The RAM 23 is utilized as a working memory employed when the CPU 21 executes processing, and acts as a buffer for temporarily storing scanned data or print data.

The scanner section 5 comprises the scanner input circuit 5a, an analog-to-digital converter 5b, and a CCD (Charge-Coupled Device) 5c. The scanner input circuit 5a drives an unillustrated scanner motor in a scanner mode and a copy mode on the basis of a control command output from the CPU 21, and generates RGB image data from an RGB image signal read by the CCD 5c.

The printer section 6 comprises the head controller 6a and a printing head 6b. The head controller 6a performs, e.g., ink ejection control of the printing head 6b or drive control of an unillustrated sheet feeding motor or a carriage motor, in the copy mode and the printer mode on the basis of the control command output from the CPU 21.

The image processor 24 operates as a color converter, a halftoning processor, and a microweaving processor. More specifically, the color converter converts multi-level RGB image data to multi-level image data of seven colors in a CMY system; i.e., cyan (C), magenta (M), yellow (Y), black (K), light cyan (LC), light magenta (LM), and dark yellow (DY). The halftoning processor binarizes the multilevel image data of the respective colors to thus generate print image data. The microweaving processor sorts raster lines of the halftoned print image data of the respective colors on the basis of the number of nozzles, the number of scans performed by the printing head, the feeding amount of the sheet, and the like, thereby generating print data. According to the provision of the image processor 24, the multifunction apparatus 2 can internally convert image data into print data to execute printing even when the multifunction apparatus 2 is not connected to the computer 3a.

The interface 25 is connected to an interface 35 of the computer 3a by way of the LAN cable 4. On the basis of the control command from the CPU 21 of the multifunction apparatus 2, the interface 25 stores, into the RAM 23, the print data transferred from the computer 3a during the printer mode. On the basis of the control command from the CPU 21 of the multifunction apparatus 2, the interface 25 transfers the scanned data read by the scanner section 5 to the computer 3a.

Upon receipt of an input of an operation signal output as a result of the user having actuated the start button 7e, the CPU 21 determines the current mode to be the scan mode and provides a command. Upon receipt of an input of an operation signal output as a result of the user having actuated the copy button 7g, the CPU 21 determines the current mode to be the copy mode and provides a command. Upon receipt, from the computer 3a, of a report to the effect that the print data have been received, the CPU 21 provides a command for print processing. Moreover, on the basis of the operation signal output from the operating section 7b of the control panel 7 or a processing status, such as the status of execution processing, display control of the display section 7a is performed.

The network TWAIN protocol 26 is for establishing communication with a TWAIN driver 42 of the computer 3a in the LAN. Upon receipt of a scanner command from the TWAIN driver 42, the CPU 21 of the multifunction apparatus 2 controls the scanner section 5, to thus transmit the scanned data to the TWAIN driver 42.

The searching protocol 27 is for establishing communication with a net scan monitor 43 of the computer 3a in the LAN. In accordance with operation of the control panel 7, the multifunction apparatus 2 transmits a search signal, to thus locate the computer 3a to 3c whose net scan monitors 43 are in operation. When the user has pressed the scan button 7d on the control panel 7, a ID signal which locates the computer and the application in the LAN is transmitted to the net scan monitor 43 of the computer along with various scanning conditions of the control panel 7.

The computer 3a comprises: a CPU 31; a ROM 32; a RAM 33; and the interface (I/F) 35 for use in connection with the LAN. For instance, an unillustrated hard disk has the TWAIN driver 42 used for operating the multifunction apparatus 2 from the computer 3a as an application 41 incorporated (installed) in the computer 3a. In addition, as the application 41, the hard disk contains a net scan module 45 consisting of: the net scan monitor 43 for establishing communication with the multifunction apparatus 2; and an event manager 44 for reporting a computer in operation to the multifunction apparatus 2. The net scan monitor 43 transmits to the multifunction apparatus 2a result of response to the search signal. The application 41 additionally includes, as other applications 41 capable of processing scanned data (image data) read by the scanner section 5 of the multifunction apparatus 2, mail software, word-processing software, drawing software, and OCR (Optical Character Recognition) software, and the like. The term “processing” used herein means that, in the case of mail software, scanned data read by the scanner section 5 are attached to a transmission message as an appended file. Alternatively, the term means that, in the case of wordprocessing software or drawing software, the scanned data read by the scanner section 5 are pasted to, e.g., a newly-created file. In addition, the application 41 includes driver software other than the TWAIN driver 42 used for operating the multifunction apparatus 2. This driver software is an application for controlling a peripheral device (an information processing device) other than the multifunction apparatus 2 from the computer 3a. For instance, the application includes driver software for operating a printer or a facsimile machine.

The CPU 31 serves as a known central processing unit for controlling the computer 3a. The ROM 32 stores various types of control programs which are necessary for the CPU 31 to execute processing. The RAM 33 is utilized as a working memory employed when the CPU 31 executes processing, and acts as a buffer for transmitting or receiving data.

The interface 35 is connected to the interface 25 of the multifunction apparatus 2 by way of the LAN cable 4. On the basis of the control command output from the CPU 31 of the computer 3a, the interface 35 returns a response signal in response to the search signal sent from the multifunction apparatus 2. Further, on the basis of the control command from the CPU 31 of the computer 3a, a control command is sent to the peripheral device of the multifunction apparatus 2.

The TWAIN driver 42 is a driver for operating the multifunction apparatus 2 from the computer 3a. In this embodiment, this driver functions so as to transmit a control command for the multifunction apparatus 2 and receive scanned data from the multifunction apparatus 2.

The net scan monitor 42 is an application for effecting communication on the basis of the searching protocol 27 of the multifunction apparatus 2, and responds to the search signal output from the multifunction apparatus 2. The net scan monitor 43 receives a ID signal which locates the computers 3a to 3c and the application in the LAN from the multifunction apparatus 2, and sends a report to the event manager 44.

The event manager 44 is activated when the computer 3a logs on to the LAN. The event manager 44 stays resident in the computer 3a, and reports to the multifunction apparatus 2 that the computer is in operation. When the event manager 44 has received the ID signal from the net scan monitor 43, a software application capable of processing scanned data (image data), such as mail software, is activated.

When the application has been launched, the TWAIN driver 42 is read, and a control command for the multifunction apparatus 2 is sent.

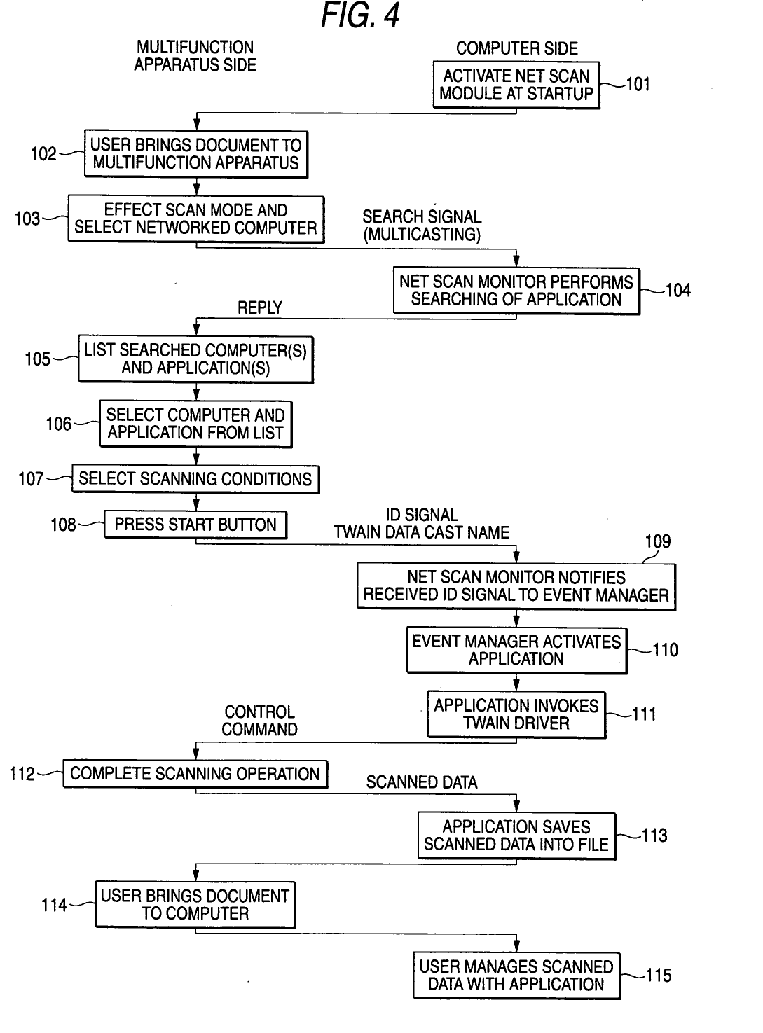

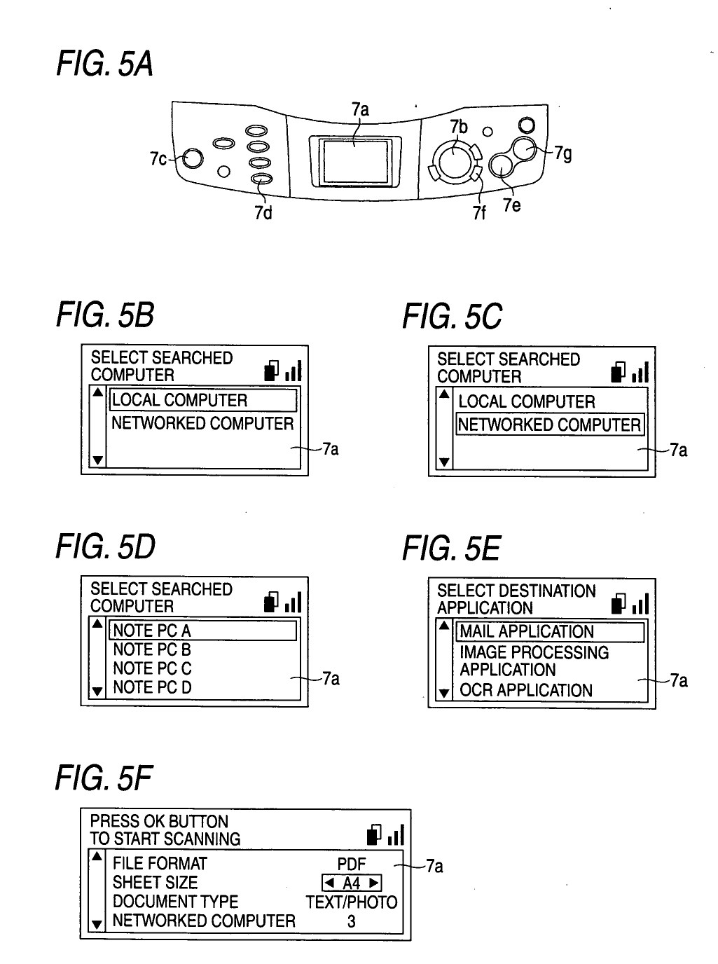

Next, a method for searching an application and a method for transmitting scanned data will be described below with reference to FIGS. 4 through 5F. These methods are executed under control of the CPU 21 of the multifunction apparatus 2 and the CPU 31 of the computer 3a.

As shown in FIG. 4, the net scan module 45 is first activated at the starting-up of the computer 3a (step 101). Next, the user brings a document to the multifunction apparatus 2 (step 102).

As shown in FIGS. 5A to 5C, the user effects the scan mode by actuating the scan button 7d, and selects “networked computer” from a menu appearing on the display section 7a (step 103). When the OK button 7f is pressed, the searching protocol 27 sends a search signal to the network. The search signal is subjected to so-called multicasting, and the multifunction apparatus 2 sends the same search signal to the computers in the LAN.

The respective computers having received the search signal search for applications incorporated in the computers, and return to the multifunction apparatus 2, as a reply, the result of search of a computer and an application from the net scan monitors 42 (step 104).

As shown in FIGS. 5D to 5F, lists of computers and applications are displayed on the control panel 7 of the multifunction apparatus 2 when the reply has been received (step 105). The user selects a computer and an application from the list (step 106), and selects scanning conditions, such as a file format, a sheet size, and a document type (step 107) After having selected scanning conditions including a computer name and an application name, the user presses the start button 7e (step 108).

The multifunction apparatus 2 transmits, to the thus-selected computer, the ID signal including the various scanning conditions and information about the multifunction apparatus (the name of the multifunction apparatus and a network address). The selected computer reports to the event manager 44 the ID signal received by the scan net monitor 43 (step 109). On the basis of the event manager 44, the CPU 31 launches software (an application) capable of processing the scanned data (image data) specified in the ID signal (step 110). The CPU 31 invokes the TWAIN driver 42 while taking launching of the application as a trigger (step 111). A method for invoking the TWAIN driver 42 while taking launching of an application as a trigger includes a method for additionally providing a link application to be interposed between an application and a TWAIN driver.

On the basis of the information about the multifunction apparatus, the CPU 31 transmits the control command to the multifunction apparatus 2 by way of the TWAIN driver 42. In accordance with the received control command, the multifunction apparatus 2 starts scanning operation. A processing progress bar is displayed on the control panel 7 of the multifunction apparatus 2, and scanning is completed (step 112). The scanned data are temporarily stored in the RAM 23, which acts as data storage means, under control of, e.g., the CPU 21. Subsequently, the scanned data are transmitted to the computer that has sent the control command by way of the network TWAIN protocol 26. The CPU 31 saves the scanned data into a file (step 113). The user brings the document to the computer (step 114), and manages the scanned data saved in the file by use of the application (step 115).

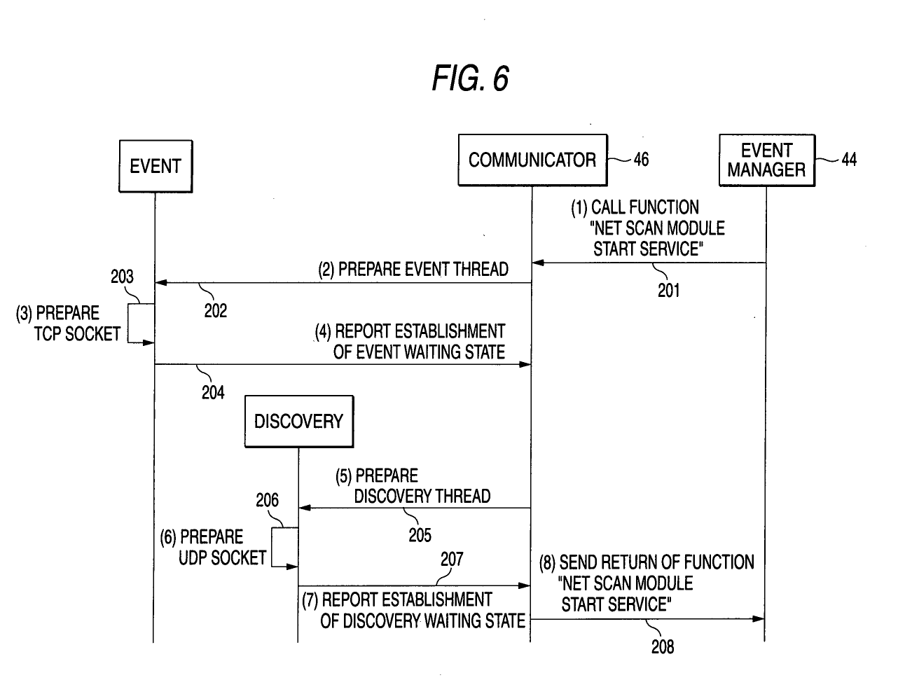

Next, processing executed by the net scan module will be described below with reference to FIGS. 6 to 8. Processing is executed under control of the CPU 31.

In FIG. 6, “event” shows processings (threads) performed in the computer which arises when the user presses the start button 7e; “communicator 46” shows communications performed between the net scan monitor 43 and the event manager 44; “event manager” shows operations executed by the event manger 44; and “discovery” shows search processings (threads) performed by the computer. The sequence in FIG. 6 shows operations performed when the computer is activated, when the event manager 44 is launched after the activation of the computer, and when the net scan monitor 43 is activated by the launched event manager 44.

The sequence shown in this figure is for establishing a state waiting for “event” and “discovery”.

The CPU 31 invokes a function (program) called “a net scan module start service” for the net scan monitor 43 by way of the event manager 44 (step 201), and prepares a thread used for establishing communication of “event” so that “event” can be awaited (step 202). The CPU 31 prepares a TCP socket (a network address of the transmission protocol) to await receipt of “event” (step 203), and reports completion of establishing a state waiting for receipt of an “event” request (step 204).

Next, a thread used for establishing communication with “discovery” is prepared (step 205). A UDP socket (a network address of a user data program) is prepared, to make the CPU await receipt of “discovery” (step 206), and completion of the establishment of a state waiting for a “discovery” request is reported (step 207). Lasty, Return of the net scan module service function is sent back to the event manager 44 (step 208).

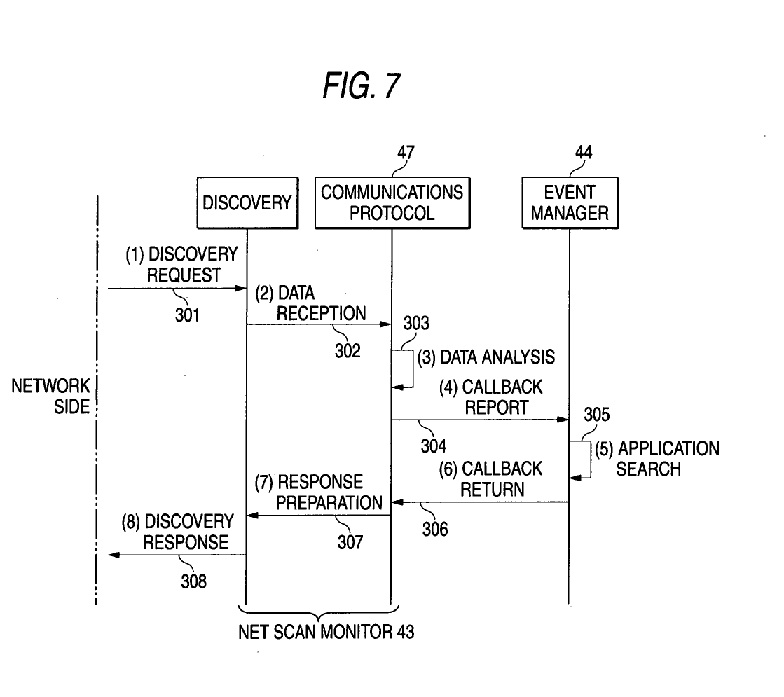

FIG. 7 is a sequence chart showing search (discovery) processing. When the discovery request (a search packet) is transmitted to the net scan monitors 43 of computers from the multifunction apparatus 2 of the network through multicasting (step 301), the communications protocol 47 receives the discovery request under control of the CPU 31 (step 302). The communications protocol 47 analyzes the received data (step 303). Here, the term “communications protocol 47” is for establishing communication between the net scan monitor 43 and the event manager 44. Communication is established between the net scan monitor 43 and the event manager 44 by way of the communications protocol 47. The communications protocol 47 reports (sends a callback) to the event manager 44 that the search packet has been received (step 304). The event manager 44 searches an application installed in the computer (step 305). The event manager 44 returns the result of search to the communications protocol 47 (return of the callback; step 306). The communications protocol 47 prepares a response (step 307). The net scan monitor 43 sends a discovery response to the transmission source of the search packet (step 308).

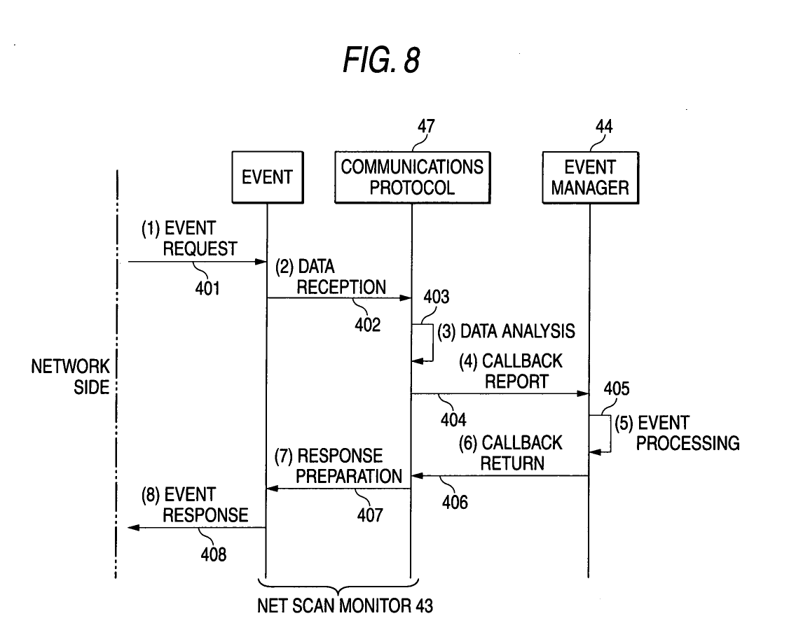

FIG. 8 is a sequence chart showing processing executed when the start button 7e of the control panel 7 is pressed.

First, when the user has pressed the start button 7e on the control panel 7, information about pressing of the start button 7e and information about actuation of the control panel (the previously-described ID signals such as various scanning conditions or the like) are sent to the net scan monitor 43 by way of a network (event requests are transmitted by use of TCPs: step 401). The communications protocol 47 receive the event requests under control of the CPU 31 (receipt of data: step 402), and the communications protocol 47 analyzes the data (step 403). The communications protocol 47 reports receipt of the ID signal (a callback) to the event manager 44 (step 404). The event manger 44 processes the thus-input event (step 405). The event processing corresponds to, e.g., initialization of software capable of processing scanned data (image data) read by the scanner section 5 of the multifunction apparatus 2. The event manager 44 returns a result of event processing to the communications protocol 47 (return of a callback: step 406). The communications protocol 47 prepares a response (step 407). The net scan monitor 42 sends an event response to the transmission source of the event request (step 408).

According to the above-described configurations, the following advantages can be obtained.
(1) Location of the computers 3a to 3c connected to the network can be carried out without previously specifying the computers 3a to 3c of the network.
(2) In addition to location of the computers 3a to 3c, search for the applications 41 of the computer 3a to 3c can also be carried out
(3) Search for driver software can also be carried out by utilization of search for the application 41 of the computer. Specifically, the multifunction apparatus 2 can ascertain which one of the computers connected to the network can operate which one of the peripheral devices.
(4) The scanned data read by the multifunction apparatus 2 are delivered to the software capable of processing the scanned data. As a result of the software saving the scanned data in a file, the user can perform so-called remote operation without going to the any of the computers 3a to 3c; namely, designation of the computer located by the multifunction apparatus 2, designation of the application 41 of the computer, initiation of the application 41, and storage of scanned data.
(5) As a result of the TWAIN driver 42 being invoked by the software (application) capable of processing the scanned data (image data), the multifunction apparatus 2 can be operated from the computer 3a without setting the IP address in the TWAIN driver 42 beforehand.

This embodiment will be modified as follows:

Network communication may be established by use of radio communication in lieu of the LAN connection embodied by the LAN cable 4. The essential requirement for network communication is to connect the devices by way of a network.

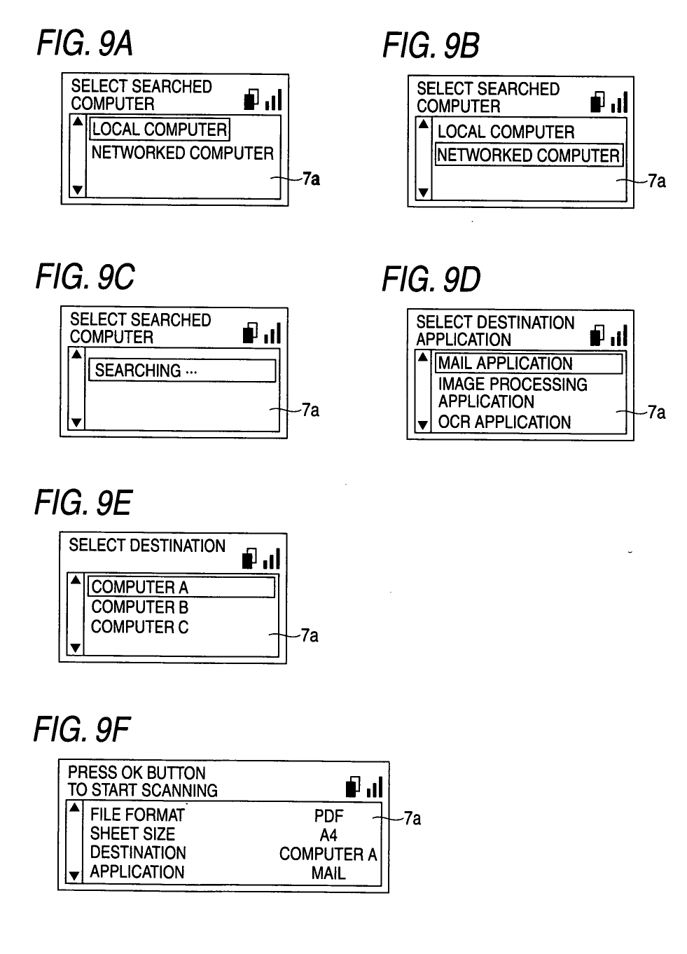

As shown in FIG. 5, in this embodiment, an application is selected after selection of a computer. However, a step, such as that shown in FIG. 9, may also be adopted. Like FIGS. 5A and 5B, FIGS. 9A and 9B show that “networked computer” is selected, and a PC and an application are searched from a network (FIG. 9C). After completion of a search, an application, which is the destination of transmission of a scanned file, is selected as shown in FIG. 9D. As shown in FIG. 9E, the multifunction apparatus 2 displays the computer installed with the application selected on the basis of the result of search. The user designates a destination computer from the computers displayed in FIG. 9E, and initiates scanning by designating scanning conditions. According to the present modification, the user can refer solely to the computer installed with the desired application, thereby providing enhanced convenience.

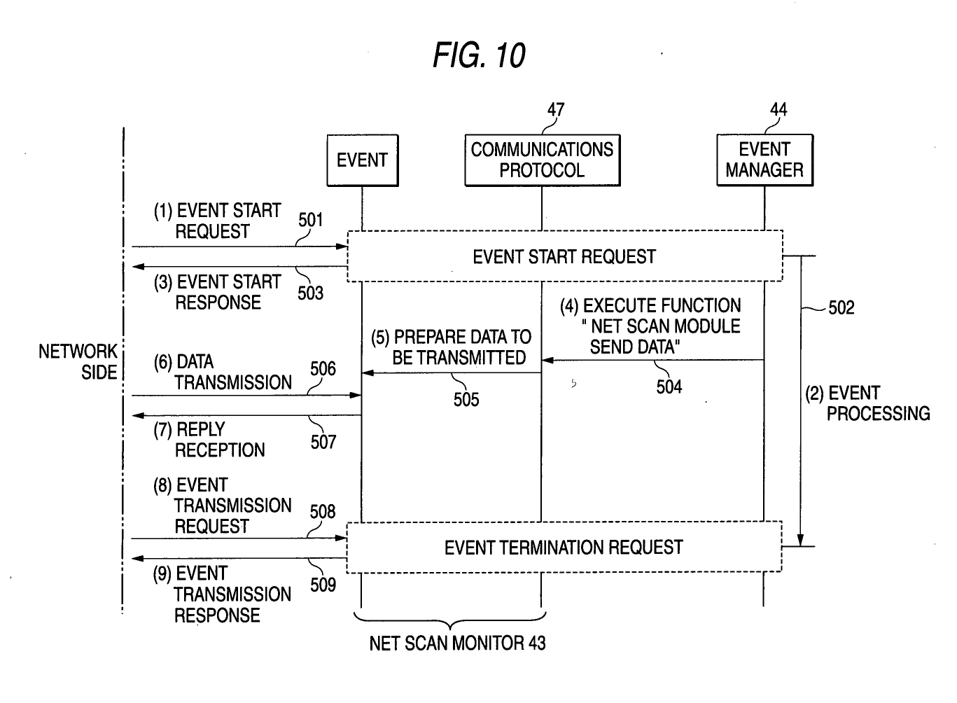

Although the sequence chart (FIG. 8) showing processing executed when the start button 7e on the control panel 7 is pressed is illustrated, processing to be executed when the start button 7e is pressed is not limited to such processing. As shown in. FIG. 10, for instance, a path used for returning, to the multifunction apparatus 2, status information achieved during processing of an event may also be provided.

As shown in FIG. 10, an event start request is transmitted from the multifunction apparatus 2 (step 501). A sequence essentially analogous to that shown in FIG. 8 is performed as an event start request. Partially contrasted with the sequence shown in FIG. 8, event processing (step 502) is not completed during the event start request, but is assumed to be completed during an event termination request to be described later. Further, according to the event start request, a result of receipt of the event start request is sent to the transmission source as a response (an event start response: step 503).

The event manager 44 transmits, to the multifunction apparatus 2, various status information items (e.g., error information and the like) acquired during event processing as a function (program) called “a net scan module send data” (step 504) by way of the communications protocol 47 (preparation of data to be transmitted: step 505) (step 506). In response to this data transmission, a reply from the multifunction apparatus 2 is received (step 507).

The event termination request is received from the multifunction apparatus 2 (step 508), and a request for termination of the event is made. A result of receipt of the event termination request is returned as a response (step 509). In connection with this event termination request, a sequence substantially analogous to the sequence shown in FIG. 8 is carried out. Partially contrasted with the sequence shown in FIG. 8, a callback of event processing is returned to the communications protocol 47, and an event response is sent back to the multifunction apparatus 2.

Although the multifunction apparatus 2 is described as having the image processor the computers 3a to 3c may have the image processor.

Instead of the computers 3a to 3c, any device may be adopted so long as the device has a communicator for establishing communication with an information processing device and being able to transmit a response result to the information processing device in response to the search signal. Such a device includes, e.g., a printer or a projector.

Instead of the multifunction apparatus 2, any device can be adopted so long as the device has a communications protocol for establishing communication with an information processing device and being able to transmit the search signal to the network. Such a device includes, e.g., a scanner or a digital camera.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. An information processing system, comprising:
a first information processing device;
a second information processing device, connected to the first information processing device by way of a network;
a communicator, provided in the first information processing device and adapted to establish communications with the second information processing device; and
a communications protocol, provided in the second information processing device, and configured to transmit a search signal indicative of a searched object to the network,
wherein the communicator is adapted to transmit a response indicative of a search result with respect to the search signal to the second information processing device.

2. The information processing system as set forth in claim 1, wherein the communicator is operable to search an application which has been installed in the first information processing device.

3. The information processing system as set forth in claim 2, wherein the application is adapted to control the second information processing device.

4. The information processing system as set forth in claim 2, wherein the application is adapted to process data transmitted from the second information processing device.

5. The information processing system as set forth in claim 2, wherein:
the second information processing device comprises an instruction provider adapted to provide a first instruction, and a display; and
the search signal is transmitted in accordance with the first instruction, and the display is adapted to display the search result.

6. The information processing system as set forth in claim 5, wherein:
the second information processing device comprises a data storage;
the instruction provider is adapted to provide a second instruction which is input in accordance with the search result displayed in the display so as to include first information about the first information processing device second information about the second information processing device and third information about the application;
the communications protocol is configured to transmit the first information, the second information, and the third information in accordance with the second instruction; and
the first information processing device is configured to activate the application in accordance with the third information, and to acquire data stored in the data storage in accordance with the second information.

7. The information processing system as set forth in claim 1, wherein the second information processing device comprises an image processor.

8. The information processing system as set forth in claim 1, wherein the first information processing device comprises an image processor.

9. An information processing device adapted to be connected to a network, comprising:
an instruction provider, adapted to provide a first instruction including a searched object;
a communications protocol, configured to transmit a search signal to the network in accordance with the first instruction, and adapted to receive a response indicative of a search result with respect to the search signal; and
a display, adapted to display the search result.

10. The information processing device as set forth in claim 9, wherein;
the instruction provider is adapted to provide a second instruction which is input in accordance with the search result displayed in the display so as to designate an external device connected to the information processing device by way of the network; and
the communications protocol is configured to transmit information to the external device in accordance with the second instruction.

11. An information processing device adapted to be connected to a network, comprising:
an application; being installed in advance; and
a communicator, adapted to receive a search signal indicative of a searched object from an external device connected to the information processing device by way of the network, to search the application as the searched object, and to transmit a response indicative of a search result with respect to the search signal to the external device.

12. The information processing device as set forth in claim 11, wherein the communicator is adapted to receive a request for activating the application from the external device, and to acquire data from the external device when the application is activated in accordance with the request.

13. An information processing method, comprising:
connecting a first information processing device and a second information processing device by way of a network;
causing the second information processing device to locate the first information processing device in the network and to search an application which has been installed in the first information processing device;
causing the first information processing device to transmit a response indicative of a search result to the second information processing device; and
causing the second information processing device to display the search result.

14. The information processing method as set forth in claim 13, further comprising:
causing the second information processing device to transmit information including an instruction which is input in accordance with the displayed search result, to the first information processing device; and
causing the first information processing device to activate the application in accordance with the instruction, and to acquire data from the second information processing device.
